(19) United States
(12) Patent Application Publication
(10) Pub. No.: US 2026/0368185 A1
(43) Pub. Date: Nov. 19, 2026

(54) Pre-emptive Tailoring of Models

(71) Applicant: MICROSOFT TECHNOLOGY LICENSING, LLC, Redmond, WA (US)

(72) Inventors: Bahareh SARRAFZADEH, Seattle, WA (US); Sheshera Shashidhar MYSORE, Northampton, MA (US); Debarati DAS, Minneapolis, MN (US)

(21) Appl. No.: 19/245,317

(22) Filed: Jun. 21, 2025

Related U.S. Application Data
(60) Provisional application No. 63/807,738, filed on May 18, 2025.

(51) Int. Cl. G06F 16/2457; G06F 9/451; G06F 16/248

(52) U.S. Cl. CPC G06F 16/24575; G06F 9/451; G06F 16/248

(57) ABSTRACT

A user's interaction with a first AI model is monitored. The interaction includes a prompt for input to the first AI model. Based on the user's interaction, an indication of user intent for the interaction is detected. Further user interaction is directed to a second AI model that is fine-tuned to the user intent based on a conversational history of interactions with a plurality of users.

### PRIORITY

This application claims the benefit of the U.S. Provisional Application Ser. No. 63/807,738 filed on May 18, 2025, entitled “PRE-EMPTIVE TAILORING OF MODELS” the entirety of which is hereby incorporated by reference herein.

### BACKGROUND

Computing systems generally provide interactive and collaborative environments that facilitate communication with various functions including interfaces to various language models. Many such systems include artificial intelligence (AI) interactions with end users. The users can have a variety of different purposes for interacting with the systems. When such environments do not optimize interactions with users, user dissatisfaction, production loss, and inefficiencies can result. It is with respect to these considerations and others that the disclosure made herein is presented.

### SUMMARY

In various embodiments, techniques are disclosed for improved human-AI alignment and interaction design for systems that provide AI-based services. The techniques are derived from follow-up patterns embedded in real conversational logs between users and AI-based systems. The disclosed techniques can be applied based on various user conversational logs to determine how users adjust, clarify, and steer AI-generated content to better align with their needs.

Specifically, the disclosed embodiments allow for AI-based systems to identify user expectations from user large language model (LLM) conversation logs where users are engaged in knowledge work tasks (e.g., content creation or writing). Users' follow-up prompts in response to a LLM's response are analyzed to identify user expectations for model behavior. The analysis indicates segments of the dataset corresponding to different user expectations. These user expectations are then correlated against fine-grained task intents expressed in the user's original prompt to the LLM. Statistically significant correlations between users' task intents and their expectations from a conversational LLM system are determined.

The disclosed techniques enable the creation of segmented datasets which enable more tailored models to be trained. The tailored models adapt their behavior depending on users' task intents, which can include the following:
i. Models are better able to coach users in learning oriented tasks, anticipating their questions and providing expert advice or feedback to users.
ii. Models are able to brainstorm with users when they seek to generate creative ideas and content.
iii. Personalize the model responses to potential readers that the model user may be generating content for, providing persuasive and easily understandable content.
iv. Personalize the model responses to the user in terms of their knowledge, style, specific behaviors, thereby improving user experience.

The examples described herein are provided within the context of collaborative environments but can be applied in any AI-based environment. Additionally, while many of the illustrated examples use large language models (LLMs), it should be noted that other models can be utilized without limiting the scope of the disclosure.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

FIG. 1 illustrates an example system showing aspects of an environment for the embodiments disclosed herein.

FIG. 2 illustrates an example of PATHs, according to embodiments disclosed herein.

FIG. 3 illustrates an example of utterance types according to one embodiment disclosed herein.

FIG. 4 illustrates an example of intent classes according to one embodiment disclosed herein.

FIGS. 5A and 5B illustrate an example of user conversations according to one embodiment disclosed herein.

FIG. 6 is a computing system diagram showing aspects of an illustrative operating environment for the technologies disclosed herein;

FIG. 7 is a computing system diagram showing aspects of an illustrative operating environment for the technologies disclosed herein;

FIG. 8 is a computing device diagram showing aspects of the configuration and operation of a device that can implement aspects of the disclosed technologies, according to one embodiment disclosed herein.

FIG. 9 is a computing system diagram showing aspects of an illustrative operating environment for the technologies disclosed herein;

FIG. 10 illustrates aspects of a routine, according to one embodiment disclosed herein;

FIG. 11 is a computing system diagram showing aspects of an illustrative operating environment for the technologies disclosed herein;

FIG. 12 is a computing device diagram showing aspects of the configuration and operation of a device that can implement aspects of the disclosed technologies, according to one embodiment disclosed herein.

### DETAILED DESCRIPTION

The following Detailed Description describes various techniques for intervention strategies for systems that use AI. Technical benefits other than those specifically described herein might also be realized through implementations of the disclosed technologies.

The disclosed technologies utilize user follow-up prompts to LLM and AI model responses to identify user expectations and intents when interacting with LLMs and other AI models. Follow-up prompts are categorized into a set of fine-grained follow-up types and recurring patterns of these follow-up types are identified. This enables the identification of a number of fine-grained types of user expectations, and the segmenting of a dataset of user-LLM conversations per these expectations. Additionally, fine-grained user expectations are correlated with user task intents or task alignment behaviors. Conventional methods of identifying user expectations and intents have been limited to analyzing the frequencies of task intents or to identifying binary notions of satisfaction/dissatisfaction based on explicit positive or negative feedback. However, user expectations can rarely be characterized by binary notions of satisfaction. As used herein, task intents can also be referred to as user intents, or more generally as intents.

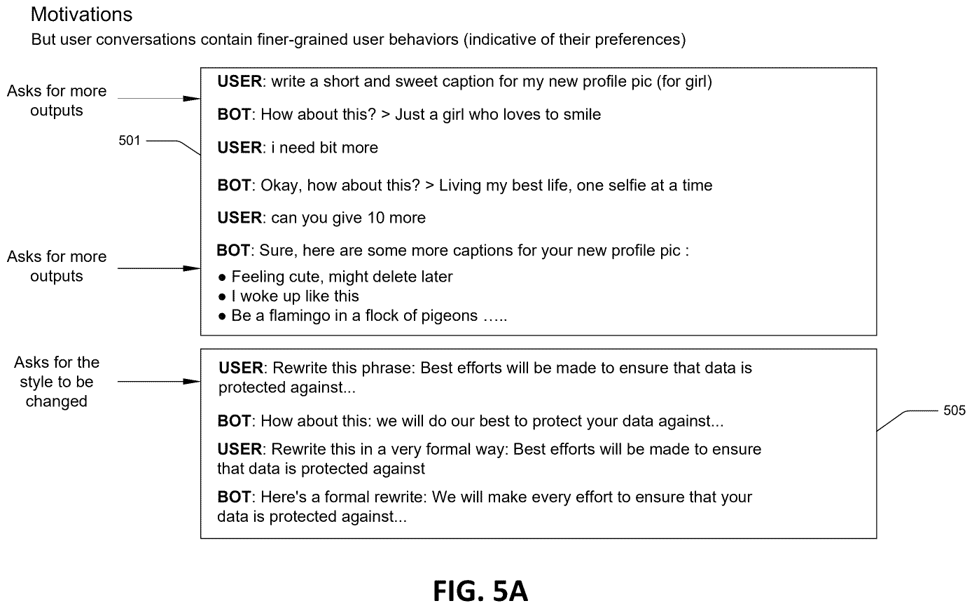

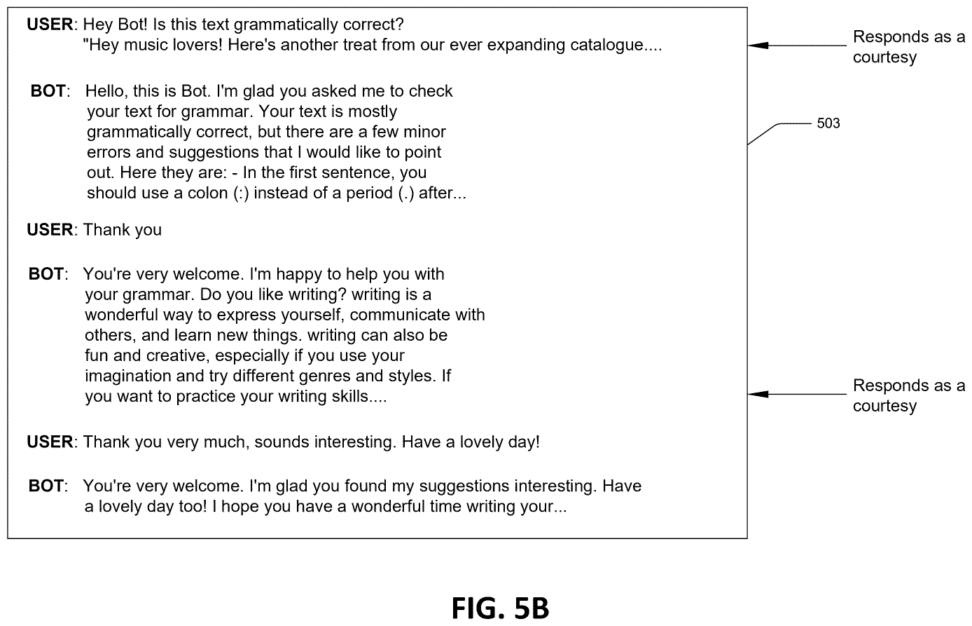

For example, referring to FIGS. 5A and 5B, the conversation 501 indicates that after the initial prompt and response, the user is asking for more outputs. This is distinct from the example shown in conversation 505, where after the initial prompt and response, the user is asking for the style to be changed. These examples are further distinct from the example shown in conversation 503, where after the initial prompt and response, the user responds with a courtesy response and does not specifically request a change.

Large language models (LLMs) support diverse user tasks, with users refining outputs through follow-up prompts. Analysis of these follow-up patterns provides deeper insights into human-AI alignment and interaction design, revealing how users adjust, clarify, and steer AI-generated content to better fit their needs. While prior research has analyzed conversation intents to identify common tasks, the prior research has not systematically examined how users iteratively refine LLM responses. Analysis of these behaviors can uncover gaps in AI assistance and inform strategies to improve LLM alignment.

The present disclosure provides methods for identifying users' Prototypical Human-AI Collaboration Behavior (PATH) in human-AI conversation logs and using the PATHs to conduct a large-scale analysis of writing tasks recorded in the logs of AI assistants. An AI assistant is generally an intelligent agent that assists users to accomplish, retrieve information, and/or engage in conversation using natural language. PATHs in writing sessions are determined by identifying frequently co-occurring patterns of follow-up prompts. Finer-grained writing intents are correlated with PATHs to determine novel and established user behaviors in tasks spanning communicative and creative LLM assisted writing.

The disclosure leverages the observation that users engage in several learning-oriented behaviors, asking questions and brainstorming as the users write. Users align texts to readers by modifying the style of generated content, and align texts to themselves by modifying the content of response generations. The disclosure leverages the observation that users engage in PATHs which vary in the degree of under-specification.

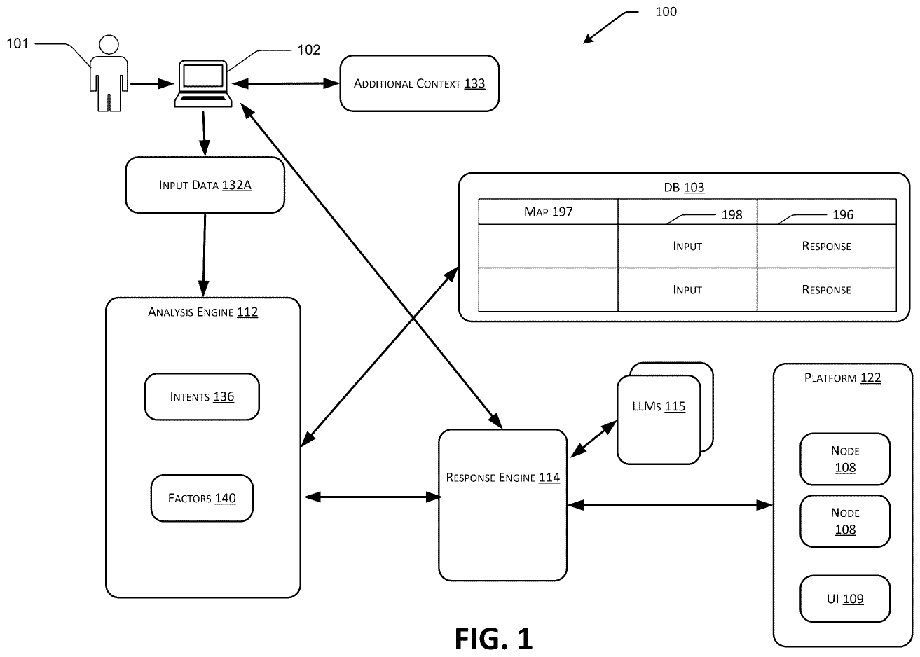

With reference to FIG. 1, an AI framework 100 is configured to receive input data 132A and optionally additional context 133 from a user 101 using device 102. The multi-platform AI framework 100 is configured to execute an analysis engine 112 that can include one or more models 115, factors 140, and optionally other features disclosed herein.

The analysis engine 112 can be implemented in one or more computing devices such as server running in the multi-platform AI framework 100. In various examples, invoking the analysis engine 112 comprises executing computational operations for receiving the input data 132A, analyzing the content of the input data 132A, determining intents 136, selecting an artificial intelligence (AI) model such as one of LLMs 115, and communicating with response engine 114 to render output from the LLMs 115 and other components in the multi-platform AI framework 100. The analysis engine 112 can include an AI model, but in some embodiments the analysis engine can be an agent or function that is not AI-based. The analysis engine 112 can monitor user interactions with other AI functions and systems, ascertain user intent based on the user interactions, select one of the LLMs 115 based on the determined user intent, and direct further user interactions with the selected LLMs.

In an embodiment, the analysis engine 112 can receive an indication that input data 132A has been received. In response to receiving the indication, the analysis engine 112 can analyze content of the input data 132A and determine an intent 136 of the user 101. In an embodiment, the intent is analyzed using factors 140 for selecting a PATH, as further described herein. For example, key elements from input data 132A can be identified. The key elements can be features that are extracted from the input data, such as direct input as well as contextual factors. The input data 132A can include, for example, text, speech, and environmental cues.

Database 103 includes mapping data 197 for mapping PATH labels. The database 103 can include one or more tables or other data structures including, for example, inputs 198 and corresponding responses 196. The data stored in database 103 can include PATH label mapping data and can be used to further inform the analysis of the content of the input data 132A. A response engine 114 can generate a response to the user 101 and can further provide inputs to platform 122 with nodes 108 and UI 109. The response can be based on an emotion label.

The disclosed analysis includes large-scale log analysis of writing session logs from LLM assistants, and correlates fine-grained writing intents expressed in users' original prompts with their follow-up response to LLM generations. User follow-ups are categorized into fine-grained follow-up types, which enables determination of novel follow-up behaviors and under-explored use cases. This enables better modeling of user expectations for model behavior and serves as a guide to LLM alignment. The disclosure extends existing concepts that identify binary signals of satisfaction/dissatisfaction from human-AI conversation logs, allowing improved characterization of user behavior. The disclosure allows for identification of novel user behaviors likely to be missed because of smaller samples or restricted study designs.

The disclosed techniques include analysis of human-AI conversation logs spanning various time periods of AI application usage. Users' original requests are labeled with fine-grained writing intents and their follow-ups with fine-grained follow-up types using, in one example, GPT-40 classifiers. Dataset level follow-up behaviors are inferred using Principal Component Analysis (PCA). The linear nature of PCA enables efficient interpretation, allowing for visualization of how follow-up types combine to form follow-up behaviors. Further, in comparison to clustering methods, the closed form solution for PCA adds stability across re-runs. After obtaining principal components which segment sessions into clusters that share the same follow-up behavior, regression analysis is run to correlate writing intents with follow-up behaviors and to identify statistically significant relationships between the writing intents and follow-up behaviors.

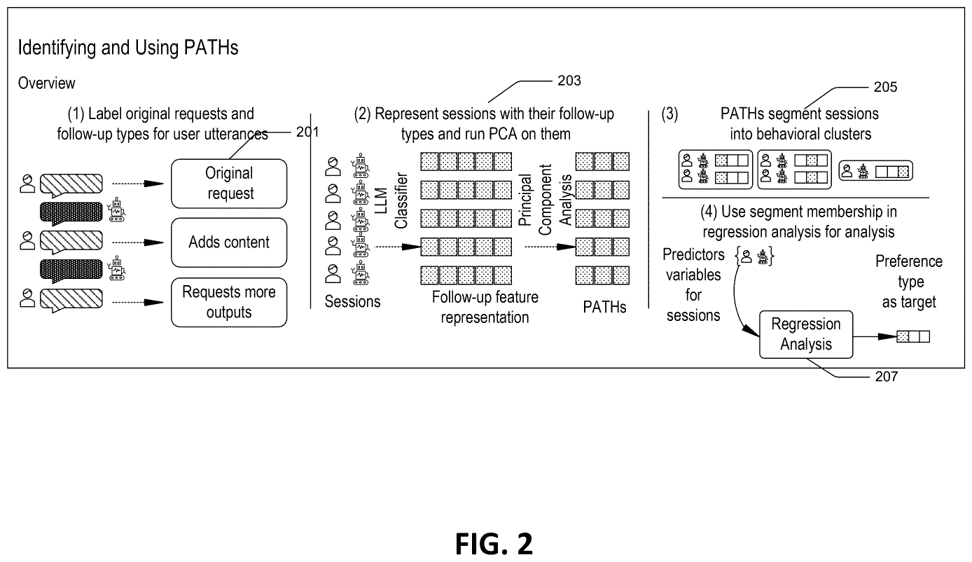

The disclosed techniques for analyzing conversational logs aim to infer correlations between intents expressed in user original requests and subsequent user behaviors captured in follow-up responses (see FIG. 2). User utterances are classified into “Original Requests” (OR) 201 and a set of follow-up types using a follow-up classifier. ORs represent the primary task that a user is attempting to accomplish in a session, and are classified into a finer-grained set of intents with an intent classifier. Patterns of follow-ups are identified by running Principal Component Analysis (PCA) 203 on sessions featurized by their follow-up types. Each identified principal component is taken as a PATH. Each PATH segments sessions into clusters 205 with a similar pattern of follow-up types. Finally, a regression analysis 207 is run, correlating intents (predictors) with PATHs (targets). This allows for identification of statistically significant correlations between intents and behaviors in a principled manner.

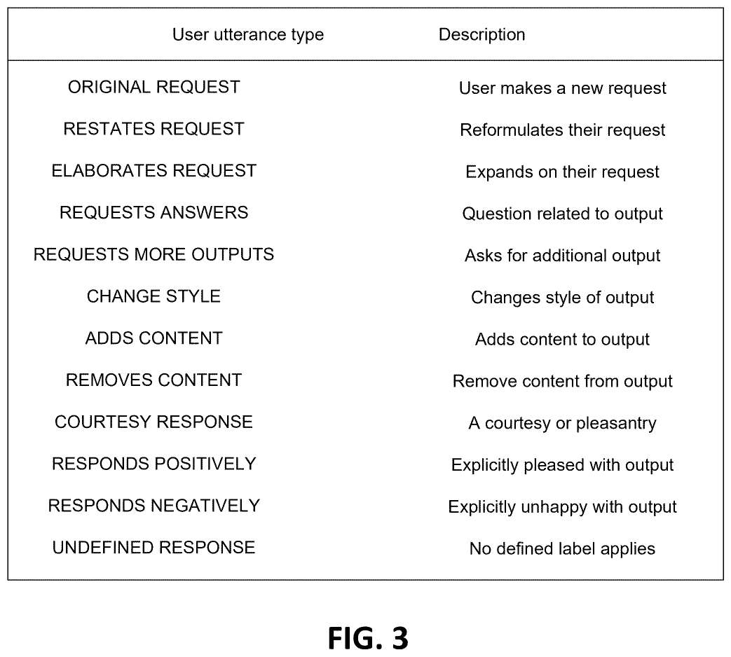

PATHs are identified from human-AI conversation logs based on users' follow-up responses to model generations. A follow-up classifier is used to classify user utterances into original requests or, in one example, one of eleven follow-up types F as illustrated in the table in FIG. 3. GPT-40, in one example, is used with a zero-shot prompt. Follow-up type labels are derived by clustering user utterances and generating labels for each cluster. The process is iteratively repeated until no new labels are generated. The labels are merged to remove redundancies.

After labeling user utterances, recurring patterns of follow-ups are identified in sessions. Given a dataset of sessions S, each session is represented with follow-up types. Each feature vector per session contains the follow-up type counts normalized by the total number of user utterances in the session. These frequencies are multiplied by the log inverse of the follow-up frequency in the entire dataset. This ensures that more frequent follow-ups do not dominate the variance of the dataset. PCA is run and each identified principal component is treated as a PATH. PCA represents a linear dimensionality reduction technique which maps F to a new space of variables, the PC scores, P=FW. The dimensions of P are uncorrelated with each other, and W ensures that the variance of F is retained in P. Further, the dimensions of P capture decreasing amounts of the variance in F. Because each dimension of P represents a mutually co-occurring set of follow-ups, they segment S into sessions with a consistent PATH.

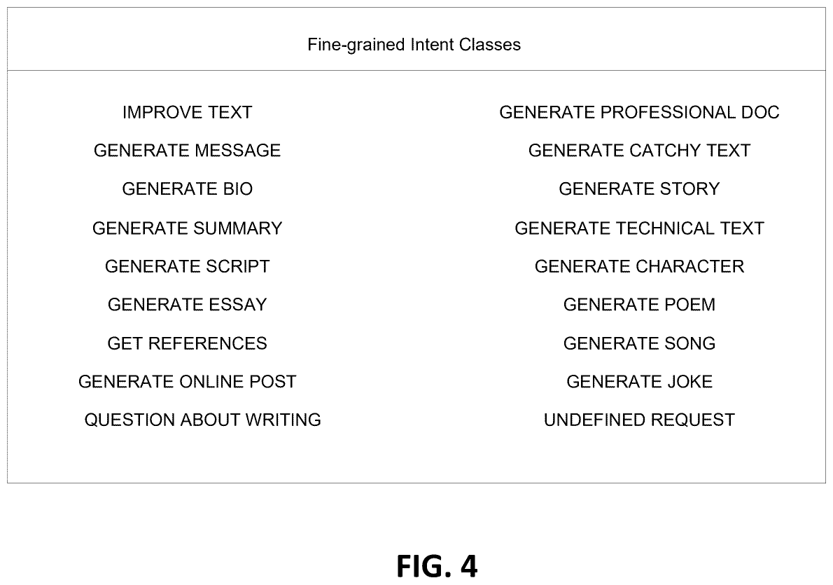

To correlate user intents with PATHs, ‘Original Requests’ are classified into fine-grained intent categories, which is illustrated in the example table in FIG. 4. A multi-label classifier is defined since requests can express more than one intent. In this example, GPT-40 is used and assigns ORs as one or more among 18 intent labels. Intent labels are derived similar to follow-up labels with repeated clustering of utterances and generating intent labels per cluster, and redundancies are resolved. GPT-40 is used in the examples described herein, but it is understood that other models and versions can be used.

To correlate intents and behaviors, logistic regression analysis is run by treating fine-grained intents of a session as predictors and the session's PATH as a target variable.

As discussed, in FIG. 2, human-AI conversation logs are analyzed with the goal of uncovering correlations between user's writing intents and their follow-up behavior as users steer model generations toward their task needs. In this regard, GPT-40 based classifiers are used to identify original requests and follow-up types. PCA is used to identify co-occurring patterns of follow-up types and take each principal component to be a PATH. The PATHs segment the sessions into clusters with a consistent follow-up behavior. Regression analysis is run by treating writing intents as predictors and PATHs as target variables and statistically significant correlations between them are identified.

The disclosed embodiments, when implemented in a system, enable identification, based on historical interactions and historical log data, which user interactions correspond to a type or category of intent. During the course of a user interaction, an initial user input and the user's subsequent responses to an AI model can be used to ascertain user intent and behavior. Conventional approaches typically only rely on the original request to identify a user intent.

In some embodiments, dimensionality reduction is used to analyze the historical interactions and historical log data. While the scope of the user responses can vary greatly, the responses can be analyzed to determine a number of patterns. The responses can be clustered into a number of kinds of behaviors which account for the variance in the data set. As an example, the analysis can indicate eight different ways that users interact with a model. Thus one aspect of the present disclosure is that in addition to the original user request, the follow-up responses are used to ascertain user intent, wherein the response types are determined based on dimensionality reduction methods. As used herein, user intent may be referred to as task alignment behaviors.

In some embodiments, each PATH can be associated with a different LLM, where each LLM is fine-tuned to each of the PATHs. In one example, based on the original request from the user, an initial model can identify how the user is likely going to behave in subsequent rounds, and further user interactions can be directed to the model that is fine-tuned to the predicted behavior. Thus a number of fine-tuned LLMs act as “behavior experts” that are trained to specialize to respond according the one of the PATHs.

The disclosed technologies can improve user interaction with a computing device by detecting user intent and behavior with an LLM request and subsequent response and fine-tuning the responses provided to the user, thus providing timely and relevant intervention and thus providing more efficient use of computing resources. Among many benefits provided by the technologies described herein, a user's interaction with a device may be improved, which may reduce the number of erroneous inputs and outputs, reduce the consumption of processing resources, and mitigate the waste of network resources. Other technical effects other than those mentioned herein can also be realized from implementations of the technologies disclosed herein.

As used herein, “AI” refers to the use of computing systems to perform intelligent tasks such as language processing, analysis, and problem solving. An example of a model utilizing AI is a Large Language Model (LLM). Although many examples in the present disclosure are illustrated using LLMs, it should be understood that the disclosure can be implemented using other models. Additionally, although many examples in the present disclosure are illustrated using AI-based systems, it should be noted that the disclosed embodiments can be implemented in systems that do not interact with or incorporate AI-based systems and technologies.

The disclosed model can support various applications across various domains in artificial intelligence, such as natural language processing (NLP) and human-computer interaction (HCI). By incorporating the disclosed model, AI systems can achieve a higher level of service quality, leading to more effective interactions.

As used herein, “AI” refers to the use of computing systems to perform intelligent tasks such as language processing, analysis, and/or problem solving. Some examples described herein refer to the use of a large language model. However, the techniques disclosed herein can utilize any combination of suitable Natural Language Processing (NLP) algorithms that analyze and model interactions between devices and human language. This can include, but is not limited to, any suitable combination of algorithms such as tokenization algorithms that divide a text into individual words or tokens; part-of-speech (POS) tagging algorithms that assign grammatical labels (e.g., noun, verb, adjective) to each word in a sentence, helping to analyze sentence structure; named entity recognition (NER) algorithms that identify and classify named entities, such as names of people, places, organizations, and more within a text; sentiment analysis algorithms that determine the sentiment or emotional tone of a piece of text, and classifying it as positive, negative, or neutral; text classification algorithms that categorize text documents into predefined classes or categories, such as topic classification and sentiment analysis; machine translation algorithms, like neural machine translation (NMT), automatically translate text from one language to another; language modeling algorithms, including n-grams and neural language models, an also to referred to herein as a large language model (LLM) or a “language model,” are used to predict the probability of a word or sequence of words given the context of the preceding words; named entity disambiguation algorithms which help disambiguate the meaning of named entities by linking them to specific entities in a knowledge base or resolving them to their appropriate entities; text summarization algorithms that generate concise summaries of longer texts, which can be extractive (selecting and combining sentences) or abstractive (generating new sentences); speech recognition algorithms, since the system may process speech messages and not just text messages; information extraction algorithms that identify structured information from unstructured text, for extracting events or facts from articles or message attachments; coreference resolution algorithms that determine which words or phrases in a text refer to the same entity, e.g., identifying that “he” and “john” refer to the same person in a sentence; question answering algorithms that answer questions posed in natural language by extracting relevant information from text corpora or knowledge bases; word embeddings algorithms that represent words as dense, continuous-valued vectors, which capture semantic relationships between words; text generation algorithms that use recurrent neural networks (RNNs) and transformers to create human-like text, including chatbots, content generation, and creative writing, dependency parsing algorithms that analyze the grammatical structure of sentences by identifying the relationships between words, including subjects, objects, and modifiers; topic modeling algorithms, such as latent Dirichlet allocation (LDA), to uncover the underlying topics in a collection of documents; and language generation algorithms that create coherent and contextually relevant language, such as generating human-like responses in a conversational AI system. In some embodiments, the system can also utilize audio-to-audio models, where audio files or audio streams are communicated to the model with a prompt for causing the models to generate the responses described herein.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLaMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise. Note also that generative image models can generate videos, and the term “image” also encompasses two-dimensional and three-dimensional video.

In some cases, a generative model can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include certain GPT variants such as GPT-40, Gemini, Chameleon, etc. Multi-modal models can also include lightweight models such as Phi-3-Vision-128K-Instruct.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc. The term “vision language model” refers to any multi-modal generative model that can generate text describing images or videos, including CLIP, BLIP, Vision-and-Language BERT, Flamingo, Chameleon, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

The disclosed techniques can utilize any type of AI Agent, agent, or large language model. For example, based on the architecture there can be at least four types of LLM that are based on the technical structure of the model: Transformer-based models: modern LLMs use this (e.g., GPT, BERT, LLaMA), Autoregressive models (e.g., GPT): Predict the next word in a sequence, Autoencoding models (e.g., BERT): Understand and fill in blanks in a sentence, and Sequence-to-sequence models (e.g., T5): Convert one text sequence to another (e.g., translate English to French). In other examples, based on the purpose or use there can be at least three types of LLMs: General-purpose models: Like GPT-4, Claude, Gemini-trained broadly for many tasks, Domain-specific models: Trained for specialized fields like medicine (e.g., BioGPT), law, finance, or coding (e.g., CodeLlama, Codex), and Instruction-tuned models: Fine-tuned to follow human instructions better (e.g., ChatGPT, Alpaca, Mistral-Instruct).

An LLM can also include a specialized language model (SLM) that is specifically trained to perform a set of functions. For example, a first SLM can be trained to determine issues with a code base, a second SLM can be trained to identify users, etc. Each SLM can be pre-trained with input data and instructions for causing each SLM to relate and identify specific sets of objects and data sets. The LLM or the SLM can be part of a server executing aspects of the present disclosure or the LLM or the SLM can be part of a separate computer in communication with the server.

The terms “AI model,” “AI Agent,” or “LLM” as used herein are intended to encompass not only individual models but also composite systems comprising multiple models. Accordingly, in some embodiments, the techniques disclosed herein may be implemented by or in connection with an AI model or AI model system. The AI model system may include, without limitation, a single model, a multimodal system, a system of models, a chain of models, or other configurations in which multiple models operate in cooperation.

The term “model” may further encompass sub-models, model systems, and mixtures of experts. For example, the model system may include specialized models delegated to perform subtasks, and these subtasks may be orchestrated by a controller or master model to achieve a complex computational result. In some embodiments, the AI system may include reasoning models, models utilizing chain-of-thought prompting techniques, or models designed for delegated task execution. Such configurations may include, but are not limited to, convolutional neural networks (CNNs), deep neural networks (DNNs), transformer-based models, or other machine learning architectures.

These models may be operable to receive one or more input types (e.g., text, image, audio), perform a set of inferential or generative operations based on the input(s), and generate output data that corresponds to predictions, classifications, recommendations, textual responses, or control instructions. The model(s) may be further configured for interoperability with user interfaces, application programming interfaces (APIs), or other software systems to support a variety of functionalities.

Regarding the figures (which might be referred to herein as a “FIG.” or “FIGS.”), additional details are provided regarding an improved prompt interface disclosed herein with reference to the accompanying drawings. The figures show, by way of illustration, specific configurations or examples. Like numerals represent like or similar elements throughout the FIGS. In the FIGS., the left-most digit(s) of a reference number generally identifies the figure in which the reference number first appears. References made to individual items of a plurality of items can use a reference number with another number included within a parenthetical (and/or a letter without a parenthetical) to refer to each individual item. Generic references to the items might use the specific reference number without the sequence of letters. The drawings are not drawn to scale.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings. Furthermore, the claimed subject matter is not limited to implementations that solve any or all disadvantages noted in any part of this disclosure.

It should be appreciated that various aspects of the subject matter described briefly above and in further detail below can be implemented as a hardware device, a computer-implemented method, a computer-controlled apparatus or device, a computing system, or an article of manufacture, such as a computer storage medium. While the subject matter described herein is presented in the general context of program modules that execute on one or more computing devices, those skilled in the art will recognize that other implementations can be performed in combination with other types of program modules. Generally, program modules include routines, programs, components, data structures, and other types of structures that perform particular tasks or implement particular abstract data types.

Those skilled in the art will also appreciate that aspects of the subject matter described herein can be practiced on or in conjunction with other computer system configurations beyond those specifically described herein, including multiprocessor systems, microprocessor-based or programmable consumer electronics, AR, VR, and MR devices, video game devices, handheld computers, smartphones, smart televisions, self-driving vehicles, smart watches, e-readers, tablet computing devices, special-purpose hardware devices, network appliances, and the others.

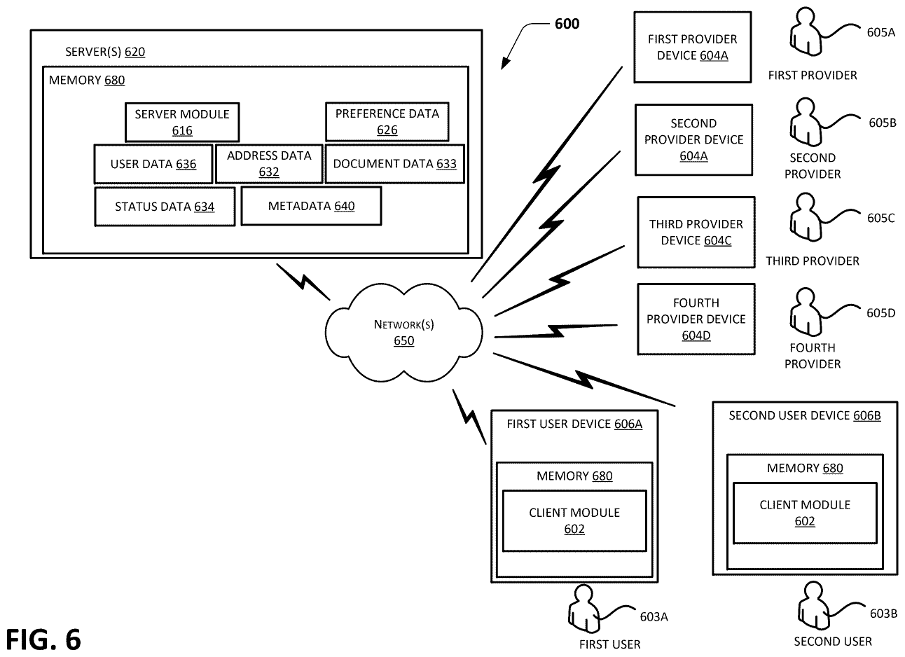

FIG. 6 is a block diagram showing aspects of one example environment 600, also referred to herein as a “system 600,” disclosed herein for providing management of prompts. In one illustrative example, the example environment 600 can include one or more servers 620, one or more networks 650, one or more user devices 606A-606B (collectively “user devices 606”), one or more provider devices 604A-604D (collectively “provider devices 604”), and one or more resources 606A-606E (collectively “resources 606”). The user devices 606 can be utilized for interaction with one or more users 603A-603B (collectively “users 603”), and the provider devices 604 can be utilized for interaction with one or more service providers 605A-605D (collectively “service providers 605”). This example is provided for illustrative purposes and is not to be construed as limiting. It can be appreciated that the example environment 600 can include any number of devices, users, providers, and/or any number of servers 620.

For illustrative purposes, the service providers 605 can be a company, person, or any type of entity capable of providing services or products for the users 603, which can also be a company, person or other entity. For illustrative purposes, the service providers 605 and the users 603 can be generically and individually referred to herein as “users.” In some configurations, a data object may include one or more messages. Contextual data can be analyzed to determine one or more messages that can be updated dynamically.

The user devices 606, provider devices 604, servers 620 and/or any other computer configured with the features disclosed herein can be interconnected through one or more local and/or wide area networks, such as the network 650. In addition, the computing devices can communicate using any technology, such as BLUETOOTH, WIFI, WIFI DIRECT, NFC or any other suitable technology, which may include light-based, wired, or wireless technologies. It should be appreciated that many more types of connections may be utilized than described herein.

A user device 606 or a provider device 604 (collectively “computing devices”) can operate as a stand-alone device, or such devices can operate in conjunction with other computers, such as the one or more servers 620. Individual computing devices can be in the form of a personal computer, mobile phone, tablet, wearable computer, including a head-mounted display (HMD) or watch, or any other computing device having components for interacting with one or more users and/or remote computers. In one illustrative example, the user device 606 and the provider device 604 can include a local memory 680, also referred to herein as a “computer-readable storage medium” or “non-transitory computer-readable storage medium” configured to store data, such as a client module 602 and other contextual data described herein.

The servers 620 may be in the form of a personal computer, server farm, large-scale system or any other computing system having components for processing, coordinating, collecting, storing, and/or communicating data between one or more computing device. In one illustrative example, the servers 620 can include a local memory 680, also referred to herein as a “computer-readable storage medium,” configured to store data, such as a server module 616 and other data described herein. The servers 620 can also include components and services, such as the application services and shown in FIG. 6, for providing, receiving, and processing prompt data and executing one or more aspects of the techniques described herein. As will be described in more detail herein, any suitable module may operate in conjunction with other modules or devices to implement aspects of the techniques disclosed herein.

In some configurations, an application programming interface (API) exposes an interface through which an operating system and application programs executing on the computing device can enable the functionality disclosed herein. Through the use of this data interface and other interfaces, the operating system and application programs can communicate and process contextual data and modify scheduling data as described herein.

The user data 636 can include various data for the users 603 and the providers 605. The user data 636 can include communication information such as a email address, job title, or other information. The user data 636 can be stored on the server 620, user device 606, provider device 604, or any suitable computing device, which may include a Web-based service.

The address data 632 may include address information for the user's contacts. The address data 632 can also be based on user data 636. These examples are provided for illustrative purposes and are not to be construed as limiting. The preference data 626 can include user-defined preferences or provider-defined preferences.

To enable aspects of the techniques disclosed herein, one or more computing devices of FIG. 6 can be configured to generate data defining one or more live updates in response to detecting the presence of a condition. The implementations can include obtaining contextual data from a plurality of resources.

One or more computing devices can be configured to identify a pattern of the contextual data indicating a presence of a condition that affects one or more aspects of a prompt.

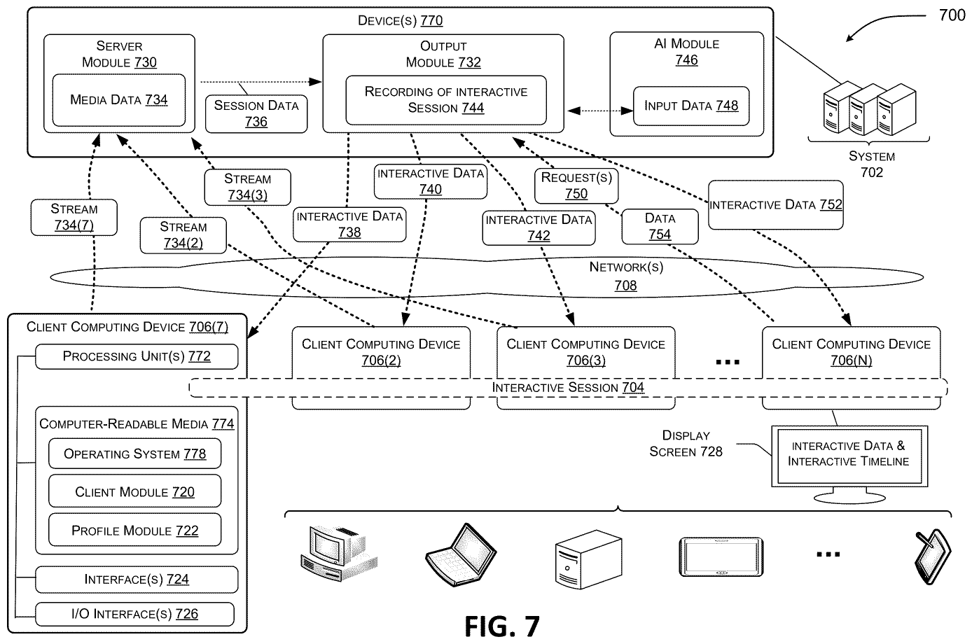

FIG. 7 is a diagram illustrating an example environment 700 in which a system 900 can operate to generate prompt information for an interactive session 704 and to save and edit content. In this example, an interactive session 704 is implemented between a number of client computing devices 706(7) through 706(N) (where N is a positive integer number having a value of two or greater). The client computing devices 706(7) through 706(N) enable users to participate in the interactive session 704. In this example, the interactive session 704 is hosted, over one or more network(s) 708, by the system 702. That is, the system 702 can provide a service that enables users of the client computing devices 706(7) through 706(N) to participate in the interactive session 704 (e.g., via a live viewing and/or a recorded viewing). Consequently, a “participant” to the interactive session 704 can comprise a user and/or a client computing device (e.g., multiple users may be in a conference room participating in a interactive session via the use of a single client computing device), each of which can communicate with other participants. As an alternative, the interactive session 704 can be hosted by one of the client computing devices 706(7) through 706(N) utilizing peer-to-peer technologies.

In examples described herein, client computing devices 706(7) through 706(N) participating in an interactive session 704 are configured to receive and render for display, on a user interface of a display screen, interactive data. The interactive data can comprise a collection of various instances, or streams, of content. For example, an individual stream of content can comprise media data associated with a video feed (e.g., audio and visual data that capture the appearance and speech of a user participating in the interactive session). Another example of an individual stream of content can comprise media data that includes a file displayed on a display screen along with audio data that captures the speech of a user. Accordingly, the various streams of content within the teleconference data enable a remote meeting to be facilitated between a group of people and the sharing of content within the group of people.

The system 702 includes device(s) 770. The device(s) 770 and/or other components of the system 702 can include distributed computing resources that communicate with one another and/or with the client computing devices 706(7) through 706(N) via the one or more network(s) 708. In some examples, the system 702 may be an independent system that is tasked with managing aspects of one or more interactive sessions such as interactive session 704. As an example, the system 702 may be managed by entities such as SLACK, WEBEX, GOTOMEETING, GOOGLE HANGOUTS, etc.

Network(s) 708 may include, for example, public networks such as the Internet, private networks such as an institutional and/or personal intranet, or some combination of private and public networks. Network(s) 708 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 708 may utilize communications protocols, including packet-based and/or datagram-based protocols such as Internet protocol (“IP”), transmission control protocol (“TCP”), user datagram protocol (“UDP”), or other types of protocols. Moreover, network(s) 708 may also include a number of devices that facilitate network communications and/or form a hardware basis for the networks, such as switches, routers, gateways, access points, firewalls, base stations, repeaters, backbone devices, and the like.

In some examples, network(s) 708 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.77 standards (e.g., 802.77g, 802.77n, and so forth), and other standards.

In various examples, device(s) 770 may include one or more computing devices that operate in a cluster or other grouped configuration to share resources, balance load, increase performance, provide fail-over support or redundancy, or for other purposes. For instance, device(s) 770 may belong to a variety of classes of devices such as traditional server-type devices, desktop computer-type devices, and/or mobile-type devices. Thus, although illustrated as a single type of device-a server-type device-device(s) 770 may include a diverse variety of device types and are not limited to a particular type of device. Device(s) 770 may represent, but are not limited to, server computers, desktop computers, web-server computers, personal computers, mobile computers, laptop computers, tablet computers, or any other sort of computing device.

A client computing device (e.g., one of client computing device(s) 706(7) through 706(N)) (each of which are also referred to herein as a “data processing system”) may belong to a variety of classes of devices, which may be the same as, or different from, device(s) 770, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (AR) device, an implanted computing device, an automotive computer, a network-enabled television, a thin client, a terminal, an Internet of Things (“IoT”) device, a work station, a media player, a personal video recorders (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 706(7) through 706(N) of the various classes and device types can represent any type of computing device having one or more processing unit(s) 772 operably connected to computer-readable media 774 such as via a bus 776, which in some instances can include one or more of a system bus, a data bus, an address bus, a PCI bus, a Mini-PCI bus, and any variety of local, peripheral, and/or independent buses.

Executable instructions stored on computer-readable media 774 may include, for example, an operating system 778, a client module 720, a profile module 722, and other modules, programs, or applications that are loadable and executable by processing units(s) 772.

Client computing device(s) 706(7) through 706(N) may also include one or more interface(s) 724 to enable communications between client computing device(s) 706(7) through 706(N) and other networked devices, such as device(s) 770, over network(s) 708. Such network interface(s) 724 may include one or more network interface controllers (NICs) or other types of transceiver devices to send and receive communications and/or data over a network. Moreover, a client computing device 706(7) can include input/output (“I/O”) interfaces 726 that enable communications with input/output devices such as user input devices including peripheral input devices (e.g., a game controller, a keyboard, a mouse, a pen, a voice input device such as a microphone, a touch input device, a gestural input device, and the like) and/or output devices including peripheral output devices (e.g., a display, a printer, audio speakers, a haptic output device, and the like). FIG. 70 illustrates that client computing device 706(N) is in some way connected to a display device (e.g., a display screen 728), which can display the interactive timeline for the interactive session 704, as shown.

In the example environment 7000 of FIG. 70, client computing devices 706(7) through 706(N) may use their respective client modules 720 to connect with one another and/or other external device(s) in order to participate in the interactive session 704. For instance, a first user may utilize a client computing device 706(7) to communicate with a second user of another client computing device 706(2). When executing client modules 720, the users may share data, which may cause the client computing device 706(7) to connect to the system 702 and/or the other client computing devices 706(2) through 706(N) over the network(s) 708.

The client computing device(s) 706(7) through 706(N) may use their respective profile module 722 to generate participant profiles and provide the participant profiles to other client computing devices and/or to the device(s) 770 of the system 702. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for interactive sessions.

As shown in FIG. 70, the device(s) 770 of the system 702 includes a server module 730 and an output module 732. The server module 730 is configured to receive, from individual client computing devices such as client computing devices 706(7) through 706(3), media streams 734(7) through 734(3). As described above, media streams can comprise a video feed (e.g., audio and visual data associated with a user), audio data which is to be output (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 730 is configured to receive a collection of various media streams 734(7) through 734(3) (the collection being referred to herein as media data 734). In some scenarios, not all the client computing devices that participate in the interactive session 704 provide a media stream. For example, a client computing device may only be a consuming, or a “listening”, device such that it only receives content associated with the interactive session 704 but does not provide any content to the interactive session 704.

The server module 730 is configured to generate session data 736 based on the media data 734. In various examples, the server module 730 can select aspects of the media data 734 that are to be shared with the participating client computing devices 706(7) through 706(N). Consequently, the server module 730 is configured to pass the session data 736 to the output module 732 and the output module 732 may communicate teleconference data to the client computing devices 706(7) through 706(3). As shown, the output module 732 transmits teleconference data 738 to client computing device 706(7), transmits teleconference data 740 to client computing device 706(2), and transmits interactive data 742 to client computing device 706(3). The interactive data transmitted to the client computing devices can be the same or can be different (e.g., positioning of streams of content within a user interface may vary from one device to the next). The output module 732 is also configured to record the interactive session (e.g., a version of the interactive data) and to maintain a recording of the interactive session 744.

The device(s) 770 can also include an AI module 746, and in various examples, the AI module 746 is configured to manage input data 748 in the session data 736 and/or events relevant to interactive session 744.

A client computing device such as client computing device 706(N) can provide a request 750 to view a recording of the interactive session 704. In response, the output module 732 can provide interactive data and interactive data 752 to be displayed on a display screen 728 associated with the client computing device 706(N). The teleconference data transmitted to client computing device 706(N) comprises previously recorded content of the interactive session 704. As further described herein, a user of client computing device 706(N) can provide input(s) to add supplemental recorded content to the interactive session 704 and/or to the interactive timeline, and data 754 associated with the supplemental recorded content can be transmitted from client computing device 706(N) to the system 702 so that the recording of the interactive session 744 and the interactive timeline can be updated with the supplemental recorded content. This enables other participants (e.g., users of client computing devices 706(7) through 706(3)) to consume or view the supplemental recorded content after the live viewing of the interactive session has already ended. An improved human-computer interface (“HCI”) is disclosed herein for interacting with representations of prompts. In some embodiments, the prompt information may be presented in conjunction with a communications platform such as a videoconferencing platform. Such a system may be referred to as an interactive chat system.

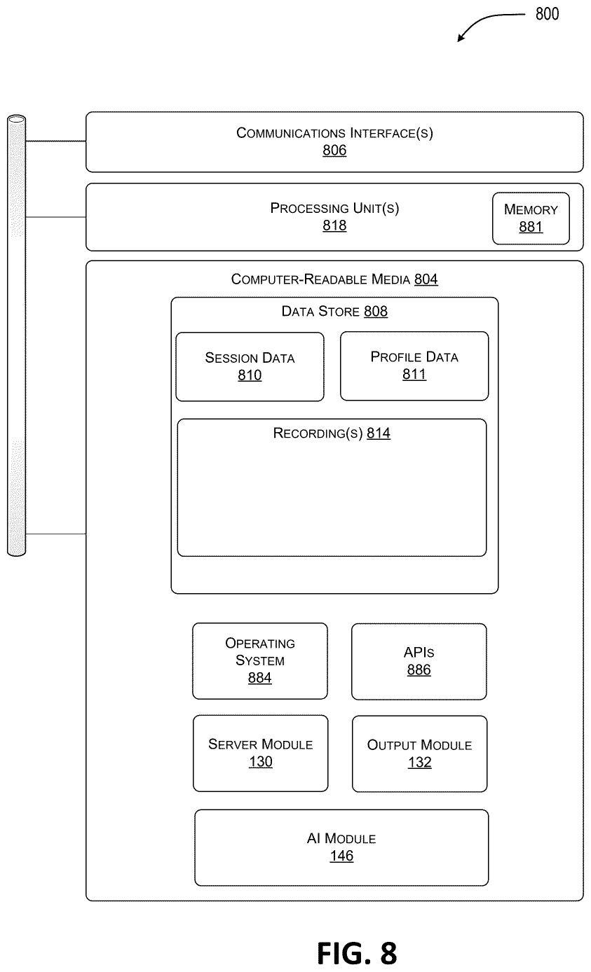

FIG. 8 illustrates a diagram that shows example components of an example device 800 configured to render and update prompt data. The device 800 may represent one of device(s) 106, or in other examples a client computing device (e.g., client computing device 106(1)), where the device 800 includes one or more processing unit(s) 818, computer-readable media 804, and communication interface(s) 806. The components of the device 800 are operatively connected, for example, via a bus, which may include one or more of a system bus, a data bus, an address bus, a PCI bus, a Mini-PCI bus, and any variety of local, peripheral, and/or independent buses.

As utilized herein, processing unit(s), such as the processing unit(s) 818 and/or processing unit(s) 88, may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 804, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 806 may represent, for example, network interface controllers (“NICs”) or other types of transceiver devices to send and receive communications over a network.

In the illustrated example, computer-readable media 804 includes a data store 808. In some examples, data store 808 includes data storage such as a database, data warehouse, or other type of structured or unstructured data storage. In some examples, data store 808 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 808 may store data for the operations of processes, applications, components, and/or modules stored in computer-readable media 804 and/or executed by processing unit(s) 818 and/or accelerator(s). For instance, in some examples, data store 808 may store session data 810 (e.g., session data 736), profile data 811 (e.g., associated with a participant profile), and/or other data. The session data 810 can include a total number of participants (e.g., users and/or client computing devices) in the interactive session 104, and activity that occurs in the interactive session 104, and/or other data related to when and how the interactive session 104 is conducted or hosted. The data store 808 can also include recording(s) 814 of interactive session(s).

Alternately, some or all of the above-referenced data can be stored on separate memories 881 on board one or more processing unit(s) 818 such as a memory on board a CPU-type processor, a GPU-type processor, an FPGA-type accelerator, a DSP-type accelerator, and/or another accelerator. In this example, the computer-readable media 804 also includes operating system 884 and application programming interface(s) 886 configured to expose the functionality and the data of the device 800 to other devices. Additionally, the computer-readable media 804 includes one or more modules such as the server module 130, the output module 132, and the AI module 146, although the number of illustrated modules is just an example, and the number may vary higher or lower. That is, functionality described herein in association with the illustrated modules may be performed by a fewer number of modules or a larger number of modules on one device or spread across multiple devices.

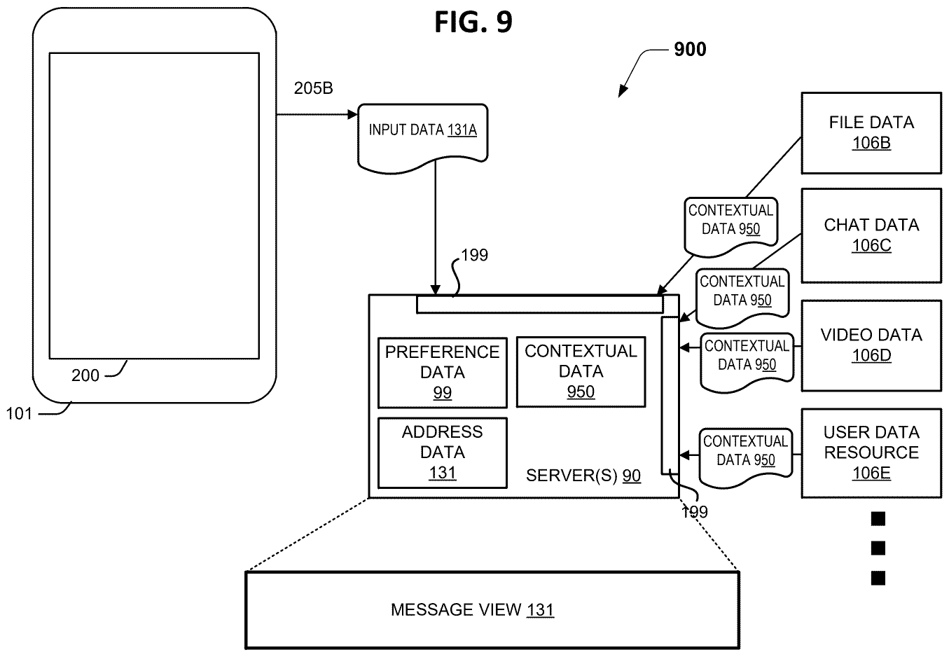

FIG. 9 illustrates aspects of the system 900 that provide a framework for several example scenarios utilizing the techniques disclosed herein. More specifically, this block diagram of the system 900 shows an illustrative example of the server 90 receiving input data 131 defining a user input. The server 90 is also storing input data 131 defining a number of inputs for a user and preference data 99. The server 90 also receives contextual data 950 from a number of resources 106A-106E, as well as other resources described herein. To illustrate aspects of the examples described below, the user device 101 is displaying a user interface (UI) 200 showing a message view.

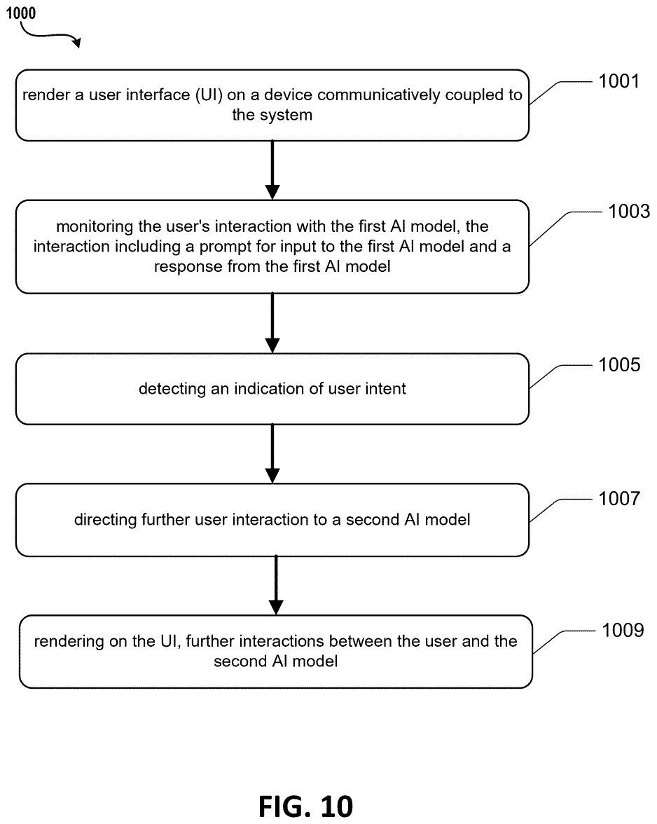

FIG. 10 is a diagram illustrating aspects of a routine 1000 according to one embodiment disclosed herein. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Additionally, the operations illustrated in FIG. 10 and the other FIGS. can be implemented in association with the example presentation GUIs described above with respect to FIGS. 1 through 12.

Referring to FIG. 10, operation 1001 illustrates rendering a user interface (UI) on a device communicatively coupled to the system, the UI for interacting with a user and providing access to a first artificial intelligence (AI) model.

Operation 1003 illustrates monitoring the user's interaction with the first AI model via the UI, the interaction including a prompt for input to the first AI model and a response from the first AI model.

Operation 1005 illustrates based on the user's interaction, detecting an indication of user intent for the interaction. In an embodiment, the user intent is one of a plurality of user intent types that are statistically correlated to user objectives for interacting with AI models.

Operation 1007 illustrates in response to detecting the indication, directing further user interaction to a second AI model selected from a plurality of tailored AI models that are each fine-tuned to one of the plurality of user intent types based on conversational histories of interactions between AI models and a plurality of users. In an embodiment, the further user interaction is directed to the second AI model without user intervention.

Operation 1009 illustrates rendering on the UI, further interactions between the user and the second AI model. In an embodiment, outputs from the second AI model are tailored to the user intent based on the second AI model having been fine-tuned to the detected user intent.

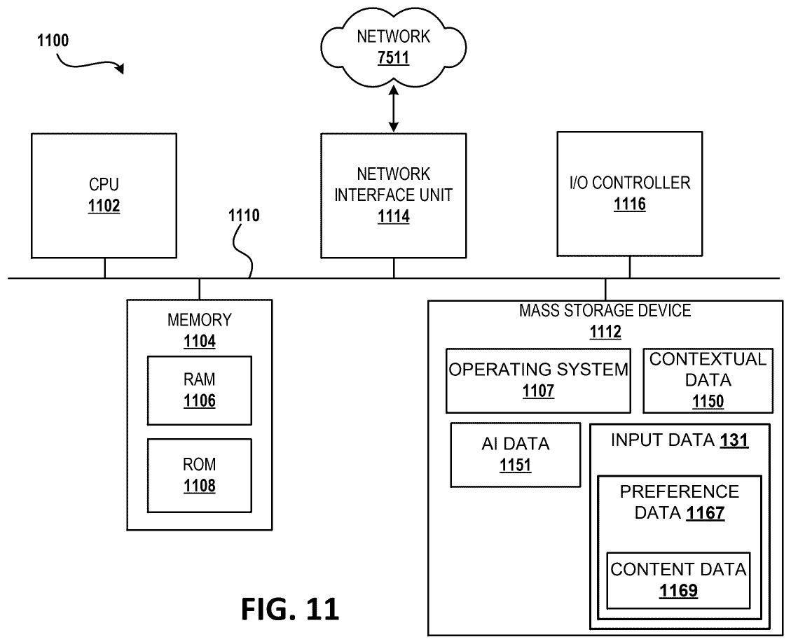

FIG. 11 shows additional details of an example computer architecture 1100 for a computer, such as any of the computing devices depicted in FIGS. 1-14, capable of executing the program components described herein. Thus, the computer architecture 1100 illustrated in FIG. 11 illustrates an architecture for a server computer, mobile phone, a PDA, a smart phone, a desktop computer, a netbook computer, a tablet computer, and/or a laptop computer. The computer architecture 1100 may be utilized to execute any aspects of the software components presented herein.

The computer architecture 1100 illustrated in FIG. 11 includes a central processing unit 1102 (“CPU”), a system memory 1104, including a random access memory 11011 (“RAM”) and a read-only memory (“ROM”) 1108, and a system bus 1110 that couples the memory 1104 to the CPU 1102. A basic input/output system containing the basic routines that help to transfer information between elements within the computer architecture 1100, such as during startup, is stored in the ROM 1108. The computer architecture 1100 further includes a mass storage device 1112 for storing an operating system 1107, data, such as the contextual data 1150, AI data 1151, input data 131, preference data 1167, content data 1169, and one or more application programs (not depicted in FIG. 11).

The mass storage device 1112 is connected to the CPU 1102 through a mass storage controller (not shown) connected to the bus 1110. The mass storage device 1112 and its associated computer-readable media provide non-volatile storage for the computer architecture 1100. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 1100.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 1100. For purposes the claims, the phrase “computer storage medium,” “computer-readable storage medium” and variations thereof, does not include waves, signals, and/or other transitory and/or intangible communication media, per se.

According to various configurations, the computer architecture 1100 may operate in a networked environment using logical connections to remote computers through the network 7511 and/or another network (not shown). The computer architecture 1100 may connect to the network 7511 through a network interface unit 1114 connected to the bus 1110. It should be appreciated that the network interface unit 1114 also may be utilized to connect to other types of networks and remote computer systems. The computer architecture 1100 also may include an input/output controller 1116 for receiving and processing input from a number of other devices, including a keyboard, mouse, or electronic stylus (not shown in FIG. 11). Similarly, the input/output controller 1116 may provide output to a display screen, a printer, or other type of output device (also not shown in FIG. 11).

It should be appreciated that the software components described herein may, when loaded into the CPU 1102 and executed, transform the CPU 1102 and the overall computer architecture 1100 from a general-purpose computing system into a special-purpose computing system customized to facilitate the functionality presented herein. The CPU 1102 may be constructed from any number of transistors or other discrete circuit elements, which may individually or collectively assume any number of states. More specifically, the CPU 1102 may operate as a finite-state machine, in response to executable instructions contained within the software modules disclosed herein. These computer-executable instructions may transform the CPU 1102 by specifying how the CPU 1102 transitions between states, thereby transforming the transistors or other discrete hardware elements constituting the CPU 1102.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 1100 in order to store and execute the software components presented herein. It also should be appreciated that the computer architecture 1100 may include other types of computing devices, including hand-held computers, embedded computer systems, personal digital assistants, and other types of computing devices known to those skilled in the art. It is also contemplated that the computer architecture 1100 may not include all of the components shown in FIG. 11, may include other components that are not explicitly shown in FIG. 11, or may utilize an architecture completely different than that shown in FIG. 11.

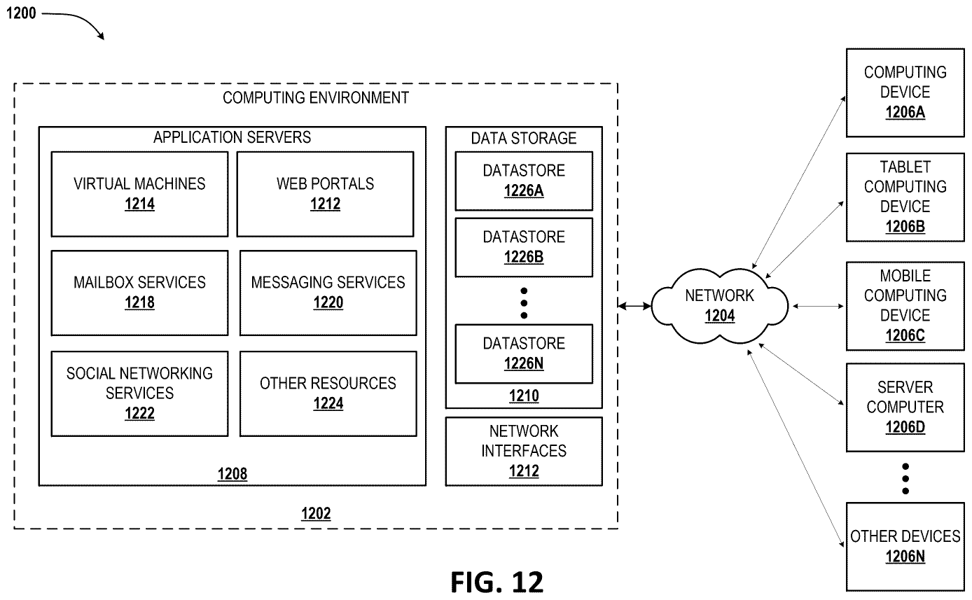

FIG. 12 depicts an illustrative distributed computing environment 1200 capable of executing the software components described herein for providing prompts. Thus, the distributed computing environment 1200 illustrated in FIG. 12 can be utilized to execute any aspects of the software components presented herein. For example, the distributed computing environment 1200 can be utilized to execute aspects of the software components described herein.

According to various implementations, the distributed computing environment 1200 includes a computing environment 1202 operating on, in communication with, or as part of the network 1204. The network 1204 may be or may include the network 1256, described above. The network 1204 also can include various access networks. One or more client devices 1206A-1206N (hereinafter referred to collectively and/or generically as “clients 1206”) can communicate with the computing environment 1202 via the network 1204 and/or other connections (not illustrated in FIG. 12). In one illustrated configuration, the clients 1206 include a computing device 1206A such as a laptop computer, a desktop computer, or other computing device; a slate or tablet computing device (“tablet computing device”) 1206B; a mobile computing device 1206C such as a mobile telephone, a smart phone, or other mobile computing device; a server computer 1206D; and/or other devices 1206N. It should be understood that any number of clients 1206 can communicate with the computing environment 1202. Two example computing architectures for the clients 1206 are illustrated and described herein with reference to FIGS. 1-15. It should be understood that the illustrated clients 1206 and computing architectures illustrated and described herein are illustrative, and should not be construed as being limited in any way.

In the illustrated configuration, the computing environment 1202 includes application servers 1208, data storage 1210, and one or more network interfaces 1212. According to various implementations, the functionality of the application servers 1208 can be provided by one or more server computers that are executing as part of, or in communication with, the network 1204. The application servers 1208 can host various services, virtual machines, portals, and/or other resources. In the illustrated configuration, the application servers 1208 host one or more virtual machines 1214 for hosting applications or other functionality. According to various implementations, the virtual machines 1214 host one or more applications and/or software modules for providing contextually-aware insights into prompts. It should be understood that this configuration is illustrative, and should not be construed as being limiting in any way. The application servers 1208 also host or provide access to one or more portals, link pages, Web sites, and/or other information (“Web portals”) 1212.

According to various implementations, the application servers 1208 also include one or more mailbox services 1218 and one or more messaging services 1220. The mailbox services 1218 can include electronic mail (“email”) services. The mailbox services 1218 also can include various personal information management (“PIM”) services including, but not limited to, calendar services, contact management services, collaboration services, and/or other services. The messaging services 1220 can include, but are not limited to, instant messaging services, chat services, forum services, and/or other communication services.

The application servers 1208 also may include one or more social networking services 1222. The social networking services 1222 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 1222 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 1222 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Washington. Other services are possible and are contemplated.

The social networking services 1222 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 1222 are not mentioned herein for the sake of brevity. As such, the above configurations are illustrative, and should not be construed as being limited in any way. According to various implementations, the social networking services 1222 may host one or more applications and/or software modules for providing the functionality described herein for providing contextually-aware insights into prompts. For instance, any one of the application servers 1208 may communicate or facilitate the functionality and features described herein. For instance, a social networking application, mail client, messaging client or a browser running on a phone or any other client 1206 may communicate with a networking service 1222 and facilitate the functionality, even in part, described above with respect to FIGS. 1-15.

As shown in FIG. 12, the application servers 1208 also can host other services, applications, portals, and/or other resources (“other resources”) 1224. The other resources 1224 can include, but are not limited to, document sharing, rendering or any other functionality. It thus can be appreciated that the computing environment 1202 can provide integration of the concepts and technologies disclosed herein provided herein with various mailbox, messaging, social networking, and/or other services or resources.

As mentioned above, the computing environment 1202 can include the data storage 1210. According to various implementations, the functionality of the data storage 1210 is provided by one or more databases operating on, or in communication with, the network 1204. The functionality of the data storage 1210 also can be provided by one or more server computers configured to host data for the computing environment 1202. The data storage 1210 can include, host, or provide one or more real or virtual data stores 1226A-1226N (hereinafter referred to collectively and/or generically as “datastores 1226”). The datastores 1226 are configured to host data used or created by the application servers 1208 and/or other data. Although not illustrated in FIG. 12, the datastores 1226 also can host or store web page documents, word documents, presentation documents, data structures, algorithms for execution by a recommendation engine, and/or other data utilized by any application program or another module. Aspects of the datastores 1226 may be associated with a service for storing files.

The computing environment 1202 can communicate with, or be accessed by, the network interfaces 1212. The network interfaces 1212 can include various types of network hardware and software for supporting communications between two or more computing devices including, but not limited to, the clients 1206 and the application servers 1208. It should be appreciated that the network interfaces 1212 also may be utilized to connect to other types of networks and/or computer systems.

It should be understood that the distributed computing environment 1200 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 1200 provides the software functionality described herein as a service to the clients 1206. It should be understood that the clients 1206 can include real or virtual machines including, but not limited to, server computers, web servers, personal computers, mobile computing devices, smart phones, and/or other devices. As such, various configurations of the concepts and technologies disclosed herein enable any device configured to access the distributed computing environment 1200 to utilize the functionality described herein for providing contextually-aware insights into prompts, among other aspects.

It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

It is to be appreciated that conditional language used herein such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

It should be also be appreciated that many variations and modifications may be made to the above-described examples, the elements of which are to be understood as being among other acceptable examples. All such modifications and variations are intended to be included herein within the scope of this disclosure and protected by the following claims.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Among many other technical benefits, the technologies herein enable more efficient use of computing resources such as processor cycles, memory, network bandwidth, and power, as compared to previous solutions relying upon inefficient manual placement of virtual objects in a 3D environment. Other technical benefits not specifically mentioned herein can also be realized through implementations of the disclosed subject matter.

Although the techniques have been described in language specific to structural features and/or methodological acts, it is to be understood that the appended claims are not necessarily limited to the features or acts described. Rather, the features and acts are described as example implementations of such techniques.

The disclosure presented herein also encompasses the subject matter set forth in the following clauses:
Clause 1: A system comprising:
   one or more data processing units; and
   a computer-readable medium having encoded thereon computer-executable instructions to cause the one or more data processing units to perform operations comprising:
   rendering a user interface (UI) on a device communicatively coupled to the system, the UI for interacting with a user and providing access to a first artificial intelligence (AI) model;
   monitoring the user's interaction with the first AI model via the UI, the interaction including a prompt for input to the first AI model and a response from the first AI model;
   based on the user's interaction, detecting an indication of user intent for the interaction, wherein the user intent is one of a plurality of user intent types that are statistically correlated to user objectives for interacting with AI models;
   in response to detecting the indication, directing further user interaction to a second AI model selected from a plurality of tailored AI models that are each fine-tuned to one of the plurality of user intent types based on conversational histories of interactions between AI models and a plurality of users, wherein the further user interaction is directed to the second AI model without user intervention; and
   rendering on the UI, further interactions between the user and the second AI model, wherein outputs from the second AI model are tailored to the user intent based on the second AI model having been fine-tuned to the detected user intent.
Clause 2: The method of clause 1, wherein the monitoring, detecting, and directing are performed by an analysis engine running on the system.
Clause 3: The method of any of clauses 1-2, wherein the monitoring, detecting, and directing are performed by the first AI model.
Clause 4: The method of any of clauses 1-3, wherein the conversational history comprises user-AI conversation logs recorded by logs of AI assistants.
Clause 5: The method of any of clauses 1-4, wherein user original requests are labeled with fine-grained writing intents and user follow-ups are labeled with fine-grained follow-up types.
Clause 6: The method of any of clauses 1-5, wherein dataset level follow-up behaviors are inferred using Principal Component Analysis (PCA).
Clause 7: The method of clauses 1-6, wherein subsequent to obtaining principal components using PCA and segmenting sessions into clusters that share follow-up behavior, regression analysis is run to correlate writing intents with follow-up behaviors and to identify statistically significant relationships between the writing intents and follow-up behaviors.
Clause 8: The method of clauses 1-7, wherein the identified follow-up behaviors are labeled as Prototypical Human-AI Collaboration Behaviors (PATHs) and are determined based on dimensionality reduction.
Clause 9: The method of clauses 1-8, wherein each PATH is associated with a different LLM, where each LLM is fine-tuned to each of the PATHs.
Clause 10: A method to be performed by a data processing system, the method comprising:
   rendering a user interface (UI) for interacting with a user and providing access to a first artificial intelligence (AI) model;
   monitoring the user's interaction with the first AI model, the interaction including a prompt for input to the first AI model;
   based on the user's interaction, detecting an indication of user intent for the interaction; and
   in response to detecting the indication, directing further user interaction to a second AI model that is fine-tuned to the user intent based on a conversational history of interactions with a plurality of users.
Clause 11: The system of clause 10, wherein the conversational history comprises user-AI conversation logs recorded by logs of AI assistants.
Clause 12: The system of any of clauses 10 and 11, wherein user original requests are labeled with fine-grained writing intents and user follow-ups are labeled with fine-grained follow-up types.
Clause 13: The system of any of clauses 10-12, wherein dataset level follow-up behaviors are inferred using Principal Component Analysis (PCA).
Clause 14: The system of any of clauses 10-13, wherein subsequent to obtaining principal components using PCA and segmenting sessions into clusters that share follow-up behavior, regression analysis is run to correlate writing intents with follow-up behaviors and to identify statistically significant relationships between the writing intents and follow-up behaviors.
Clause 15: The system of any of clauses 10-14, wherein the identified follow-up behaviors are labeled as PATHs and are determined based on dimensionality reduction.
Clause 16: The system of any of clauses 10-15, wherein each PATH is associated with a different LLM, where each LLM is fine-tuned to each of the PATHs.
Clause 17: A computer-readable storage medium having computer-executable instructions stored thereupon which, when executed by one or more processors of a computing device, cause the computing device to perform operations comprising:
   rendering a user interface (UI) for interacting with a user and providing access to a first artificial intelligence (AI) model;
   monitoring the user's interaction with the first AI model, the interaction including a prompt for input to the first AI model;
   based on the user's interaction, detecting an indication of user intent for the interaction; and
   in response to detecting the indication, directing further user interaction to a second AI model that is fine-tuned to the user intent based on a conversational history of interactions with a plurality of users.
Clause 18: The computer-readable storage medium of clause 17, wherein the conversational history comprises user-AI conversation logs recorded by logs of AI assistants.
Clause 19: The computer-readable storage medium of any of clauses 17 and 18, wherein user original requests are labeled with fine-grained writing intents and user follow-ups are labeled with fine-grained follow-up types.
Clause 20: The computer-readable storage medium of any of clauses 17-19, wherein: dataset level follow-up behaviors are inferred using Principal Component Analysis (PCA);
   subsequent to obtaining principal components using PCA and segmenting sessions into clusters that share follow-up behavior, regression analysis is run to correlate writing intents with follow-up behaviors and to identify statistically significant relationships between the writing intents and follow-up behaviors; and
   the identified follow-up behaviors are labeled as PATHs and are determined based on dimensionality reduction.

1. A system comprising:
one or more data processing units; and
a computer-readable medium having encoded thereon computer-executable instructions to cause the one or more data processing units to perform operations comprising:
rendering a user interface (UI) on a device communicatively coupled to the system, the UI for interacting with a user and providing access to a first artificial intelligence (AI) model;
monitoring the user's interaction with the first AI model via the UI, the interaction including a prompt for input to the first AI model and a response from the first AI model;
based on the user's interaction, detecting an indication of user intent for the interaction, wherein the user intent is one of a plurality of user intent types that are statistically correlated to co-occurring patterns of follow-up types identified from conversational histories of interactions between AI models and a plurality of users, each of the co-occurring patterns representing a recurring combination of follow-up types in sessions of the conversational histories;
in response to detecting the indication, selecting one of the co-occurring patterns correlated to the detected user intent and selecting, based on the selected co-occurring pattern, a second AI model from a plurality of tailored AI models, each tailored AI model being fine-tuned to a respective co-occurring pattern using a segmented dataset corresponding to the respective co-occurring pattern, wherein the second AI model is fine-tuned to the selected co-occurring pattern, and wherein further user interaction is directed to the second AI model without user intervention; and
rendering on the UI, further interactions between the user and the second AI model, wherein outputs from the second AI model are tailored to the detected user intent based on the second AI model having been fine-tuned to the selected co-occurring pattern.

2. The system of claim 1, wherein the monitoring, detecting, selecting, and directing are performed by an analysis engine running on the system.

3. The system of claim 1, wherein the monitoring, detecting, selecting, and directing are performed by the first AI model.

4. The system of claim 1, wherein the conversational histories comprise user-AI conversation logs recorded by AI assistants.

5. The system of claim 4, wherein user original requests in the conversational histories are labeled with fine-grained writing intents and user follow-ups in the conversational histories are labeled with fine-grained follow-up types.

6. The system of claim 5, wherein dataset level follow-up behaviors are inferred by representing sessions in the conversational histories using follow-up-type feature representations and applying Principal Component Analysis (PCA) to the follow-up-type feature representations.

7. The system of claim 6, wherein subsequent to obtaining principal components using PCA and segmenting sessions into clusters that share follow-up behavior, regression analysis is run to correlate writing intents with follow-up behaviors and to identify statistically significant relationships between the writing intents and follow-up behaviors.

8. The system of claim 7, wherein each of the co-occurring patterns comprises a principal component corresponding to a co-occurring pattern of follow-up types that segments sessions into a behavioral cluster.

9. The system of claim 1, wherein the plurality of tailored AI models comprise a plurality of large language models (LLMs) trained to specialize in responding according to different co-occurring patterns of follow-up types.

10. A method to be performed by a data processing system, the method comprising:
rendering a user interface (UI) for interacting with a user and providing access to a first artificial intelligence (AI) model;
monitoring the user's interaction with the first AI model, the interaction including a prompt for input to the first AI model;
based on the user's interaction, detecting an indication of user intent for the interaction, wherein the user intent is one of a plurality of user intent types that are statistically correlated to co-occurring patterns of follow-up types identified from conversational histories of interactions between AI models and a plurality of users, each of the co-occurring patterns representing a recurring combination of follow-up types in sessions of the conversational histories;
in response to detecting the indication, selecting one of the co-occurring patterns correlated to the detected user intent;
selecting, based on the selected co-occurring pattern, a second AI model from a plurality of tailored AI models, each tailored AI model being fine-tuned to a respective co-occurring pattern using a segmented dataset corresponding to the respective co-occurring pattern, wherein the second AI model is fine-tuned to the selected co-occurring pattern; and
directing further user interaction to the second AI model without user intervention.

11. The method of claim 10, further comprising rendering on the UI further interactions between the user and the second AI model, wherein outputs from the second AI model are tailored to the detected user intent based on the second AI model having been fine-tuned to the selected co-occurring pattern.

12. The method of claim 11, wherein the conversational histories comprise user-AI conversation logs recorded by AI assistants.

13. The method of claim 12, wherein original requests in the conversational histories are labeled with fine-grained writing intents and user follow-ups in the conversational histories are labeled with fine-grained follow-up types.

14. The method of claim 13, wherein dataset-level follow-up behaviors are inferred by representing sessions in the conversational histories using follow-up-type feature representations and applying Principal Component Analysis (PCA) to the follow-up-type feature representations.

15. The method of claim 14, wherein, subsequent to obtaining principal components using PCA and segmenting the sessions into clusters that share follow-up behavior, regression analysis is run to correlate writing intents with follow-up behaviors and to identify statistically significant relationships between the writing intents and the follow-up behaviors.

16. The method of claim 10, wherein each of the co-occurring patterns comprises a principal component corresponding to a co-occurring pattern of follow-up types that segments sessions into a behavioral cluster, and wherein the plurality of tailored AI models comprise a plurality of large language models (LLMs) trained to specialize in responding according to different co-occurring patterns of follow-up types.

17. A computer-readable storage medium having computer-executable instructions stored thereupon which, when executed by one or more processors of a computing device, cause the computing device to perform operations comprising:
rendering a user interface (UI) for interacting with a user and providing access to a first artificial intelligence (AI) model;
monitoring the user's interaction with the first AI model, the interaction including a prompt for input to the first AI model;
based on the user's interaction, detecting an indication of user intent for the interaction, wherein the user intent is one of a plurality of user intent types that are statistically correlated to co-occurring patterns of follow-up types identified from conversational histories of interactions between AI models and a plurality of users, each of the co-occurring patterns representing a recurring combination of follow-up types in sessions of the conversational histories;
in response to detecting the indication, selecting one of the co-occurring patterns correlated to the detected user intent;
selecting, based on the selected co-occurring pattern, a second AI model from a plurality of tailored AI models, each tailored AI model being fine-tuned to a respective co-occurring pattern using a segmented dataset corresponding to the respective co-occurring pattern, wherein the second AI model is fine-tuned to the selected co-occurring pattern; and
directing further user interaction to the second AI model without user intervention.

18. The computer-readable storage medium of claim 17, wherein the conversational histories comprise user-AI conversation logs recorded by AI assistants.

19. The computer-readable storage medium of claim 18, wherein original requests are labeled with fine-grained writing intents and user follow-ups in the conversational histories are labeled with fine-grained follow-up types.

20. The computer-readable storage medium of claim 17, wherein:
dataset level follow-up behaviors are inferred by representing sessions in the conversational histories using follow-up-type feature representations and applying Principal Component Analysis (PCA) to the follow-up-type feature representations;
subsequent to obtaining principal components using PCA and segmenting sessions into clusters that share follow-up behavior, regression analysis is run to correlate writing intents with follow-up behaviors and to identify statistically significant relationships between the writing intents and follow-up behaviors; and
each of the co-occurring patterns comprises a principal component corresponding to a co-occurring pattern of follow-up types that segments sessions into a behavioral cluster.
